(19) United States
(12) Patent Application Publication
(10) Pub. No.: US 2026/0322093 A1
(43) Pub. Date: Oct. 15, 2026

(54) FLEXIBLE BUSBAR

(71) Applicant: SUNCALL CORPORATION, Kyoto (JP)

(72) Inventor: Aoi AKIYAMA, Kyoto (JP)

(21) Appl. No.: 19/693,073

(22) Filed: May 29, 2026

Related U.S. Application Data
(63) Continuation of application No. PCT/JP2025/030834, filed on Sep. 2, 2025.

(30) Foreign Application Priority Data
Sep. 4, 2024 (JP) 2024-152382

(51) Int. Cl. H02G 5/00

(52) U.S. Cl. CPC H02G 5/005

(57) ABSTRACT

A flexible bus bar includes a flexible bus bar main body having flexibility; and a left fixing portion and a right fixing portion 2b1 for fixing both side portions of the flexible bus bar main body. When performing a bending process on the flexible bus bar main body at a bending line, a bending-specific fixing portion that includes the bending line is formed on the flexible bus bar main body in addition to the left fixing portion and the right fixing portion. The flexible bus bar that is capable of improving appearance and stabilizing the quality of a product.

### FIELD OF THE INVENTION

The present invention relates to a flexible bus bar.

### BACKGROUND OF THE INVENTION

In general, it is known to use a flexible bus bar in connecting energizable members (for example, batteries mounted in electric vehicles, hybrid vehicles, or the like).

As such a flexible bus bar, for example, one described in Japanese Published Unexamined Patent Application No. 2008-41330 is known.

### SUMMARY OF THE INVENTION

When the flexible bus bar as described above is subjected to a bending process, the following problem has arisen. This point will be specifically described with reference to FIGS. 4 and 5.

As shown in FIG. 4(a), a conventional flexible bus bar 100 includes a flexible bus bar main body 101 having a horizontally long rectangular shape. As shown in FIG. 4(b), the flexible bus bar main body 101 is formed by laminating conductive material foils 102 made of a thin plate-shaped, flexible metal such as copper. It is noted that the flexible bus bar main body 101 formed in this manner can carry a large current.

Thus, in the flexible bus bar main body 101 configured in this manner, as shown in FIG. 4(a), a left side surface 101a side is fixed to form a left fixing portion 101a1, and a right side surface 101b side is fixed to form a right fixing portion 101b1. As a result, as shown in FIG. 4(a), an unfixed portion 101c is formed between the left fixing portion 101a1 and the right fixing portion 101b1. Therefore, a flexible bus bar 100 as shown in FIG. 4(a) is formed in this manner. It is noted that the unfixed portion 101c has flexibility.

Thus, when the flexible bus bar 100 formed in this manner is bent by 90 degrees along a bending line S100 shown in FIG. 4(a), the state shown in FIG. 4(b) is obtained. That is, as shown in FIG. 4(b), since the unfixed portion 101c is involved in the bending process of 90 degree, a distance difference occurs between the conductive material foil 102 located on an outermost peripheral surface 101ca side of the unfixed portion 101c and the conductive material foil 102 located on an innermost peripheral surface 101cb side of the unfixed portion 101 c when bending is performed by 90 degrees along the bending line S100 shown in FIG. 4(a), thereby causing an inner-outer difference. Accordingly, when the left fixing portion 101a1 and the right fixing portion 101b1 are formed as shown in FIG. 4(a) and 4(b), the conductive material foil 102 located on the innermost peripheral surface 101cb side of the unfixed portion 101c bulges, as shown in FIG. 4(b), due to the inner-outer difference, and a phenomenon in which wrinkles are formed occurs. The flexible bus bar 100 in which such a phenomenon has occurred has a poor appearance and has had a problem in that energizable members (for example, batteries mounted in electric vehicles, hybrid vehicles, or the like) cannot be appropriately connected for reasons such as a size mismatch.

Thus, in order to solve the problem as described above, a method as shown in FIG. 5 can be considered.

That is, as shown in FIG. 5(a), only the left side surface 101a side of the flexible bus bar main body 101 is fixed to form a left fixing portion 101a1. Then, in this state, when bending by 90 degrees is performed along a bending line S101 shown in FIG. 5(a), the state shown in FIG. 5(b) is obtained. That is, as shown in FIG. 5(b), since the unfixed portion 101c is involved in the bending process of 90 degrees, a distance difference appears between the conductive material foil 102 located on the outermost peripheral surface 101ca side of the unfixed portion 101c and the conductive material foil 102 located on the innermost peripheral surface 101cb side of the unfixed portion 101c when bending by 90 degrees is performed along the bending line S101 shown in FIG. 5(a). However, as shown in FIG. 5(b), since the right fixing portion 101b1 is not formed, the length on the conductive material foil 102 side located on the outermost peripheral surface 101ca side of the unfixed portion 101c becomes longer, and the length gradually becomes shorter toward the conductive material foil 102 located on the innermost peripheral surface 101cb side of the unfixed portion 101c. As a result, the occurrence of the phenomenon in which wrinkles are formed as shown in FIG. 4(b) can be prevented.

Thereafter, as shown in FIG. 5(c), the right side surface 101b side of the flexible bus bar main body 101 is fixed to form a right fixing portion 101b1. At this time, in order to align the end surface of the right fixing portion 101b1 (the right side surface 101b of the flexible bus bar main body 101) shown in FIG. 5(c), the right fixing portion 101b1 is cut along a cutting line S102. As a result, the flexible bus bar 100 can be bent by 90 degrees along the bending line S101 shown in FIG. 5(a) without the occurrence of the phenomenon in which wrinkles are formed as shown in FIG. 4(b).

However, this method has had a problem in that not only does the number of cutting steps increase, but product variation also tends to occur, and the quality of products may become unstable.

Thus, in view of the problem described above, an object of the present invention is to provide a flexible bus bar that can not only improve appearance but also stabilize the quality of a product.

The foregoing object of the present invention is achieved by the following means. It is noted that reference signs in an embodiment to be described later are added in parentheses, but the present invention is not limited thereto.

According to a first embodiment, the flexible bus bar (1) includes:
a flexible bus bar main body (2) having flexibility; and
first fixing portions (left fixing portion 2a1, right fixing portion 2b1) that fix both side portions of the flexible bus bar main body (2),
wherein, upon bending of the flexible bus bar main body (2) at a predetermined position (bending line S1), a second fixing portion (bending-specific fixing portion 2d) that includes the predetermined position (bending line S1) is formed on the flexible bus bar main body (2) in addition to the first fixing portions (left fixing portion 2a1, right fixing portion 2b1).

In a second embodiment, in addition to the features of the first embodiment, the flexible bus bar further includes, wherein, upon bending of the flexible bus bar main body (2) at each of a plurality of predetermined positions, the second fixing portion (bending-specific fixing portion 2d) is formed on the flexible bus bar main body (2) at each of the plurality of predetermined positions so as to include a respective one of the plurality of predetermined positions, in addition to the first fixing portions (left fixing portion 2a1, right fixing portion 2b1).

In a third embodiment, in addition to the features of one or both of the first and second embodiments, the flexible bus bar further includes, wherein the first fixing portions (left fixing portion 2a1, right fixing portion 2b1) and the second fixing portion (bending-specific fixing portion 2d) are formed by thermal bonding.

Next, advantageous effects of the present invention will be described with reference signs in the drawings. It is noted that reference signs in an embodiment to be described later are added in parentheses, but the present invention is not limited thereto.

According to the invention of the first embodiment, upon bending of the flexible bus bar main body (2) at a predetermined position (bending line S1), the second fixing portion (bending-specific fixing portion 2d) that includes the predetermined position (bending line S1) is formed on the flexible bus bar main body (2). As a result, even when a bending process is performed at the predetermined position (bending line S1) of the flexible bus bar main body (2), the portion of the flexible bus bar main body (2) having flexibility (for example, the unfixed portion (2c) as shown in FIG. 1) is not affected.

Therefore, according to the present invention, not only can appearance be improved, but also the quality of a product can be stabilized.

Further, according to the present invention, since the second fixing portion (bending-specific fixing portion 2d) is formed only in a portion including the predetermined position (bending line S1), the flexibility of the portion of the flexible bus bar main body (2) having flexibility (for example, the unfixed portion (2c) as shown in FIG. 1) can be exhibited to the maximum extent.

According to the second embodiment, when the second fixing portion (bending-specific fixing portion 2d) is formed on the flexible bus bar main body (2) at each of a plurality of predetermined positions so as to include a respective one of the plurality of predetermined positions, a complicated bending process becomes possible.

According to the third embodiment, there is no possibility that a brazing material used in solder or the like will melt when heat is applied to the flexible bus bar (1). Furthermore, there is no possibility of failure to obtain a resistance value required for the flexible bus bar (1) due to the influence of a member used in solder or the like.

### BRIEF DESCRIPTION OF THE DRAWINGS

FIG. 1(a) is a plan view of a flexible bus bar according to one embodiment of the present invention, and FIG. 1(b) is a side view when the flexible bus bar according to the embodiment is bent by 90 degrees.

FIG. 2 is a side view when the flexible bus bar according to the embodiment is bent in a stair-step shape.

FIG. 3 is a side view when the flexible bus bar according to the embodiment is bent in a U-shape.

FIG. 4(a) is a plan view of a conventional flexible bus bar, and FIG. 4(b) is a side view when the flexible bus bar of FIG. 4(a) is bent by 90 degrees.

FIG. 5(a) is a plan view of a conventional flexible bus bar, FIG. 5(b) is a side view when the flexible bus bar of FIG. 5(a) is bent by 90 degrees, and FIG. 5(c) is an explanatory view illustrating the state in which cutting is being performed.

### DETAILED DESCRIPTION OF THE PREFERRED EMBODIMENTS

Hereinafter, a flexible bus bar according to one embodiment of the present invention will be specifically described with reference to the drawings. It is noted that, in the following description, when upper, lower, left, and right directions are indicated, the upper, lower, left, and right directions mean the upper, lower, left, and right directions as viewed from the front in the drawings.

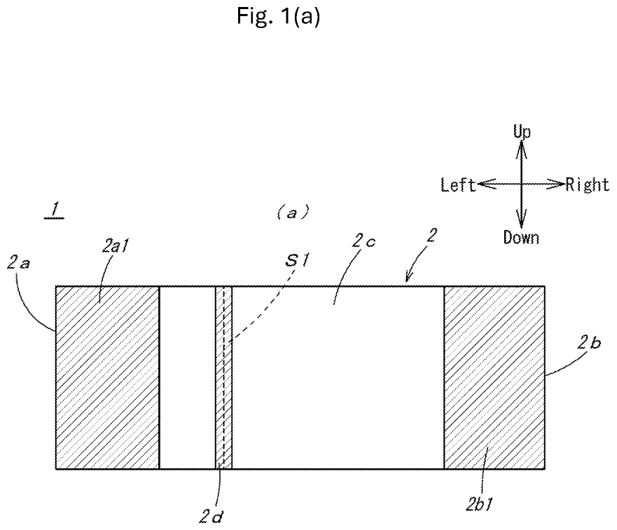

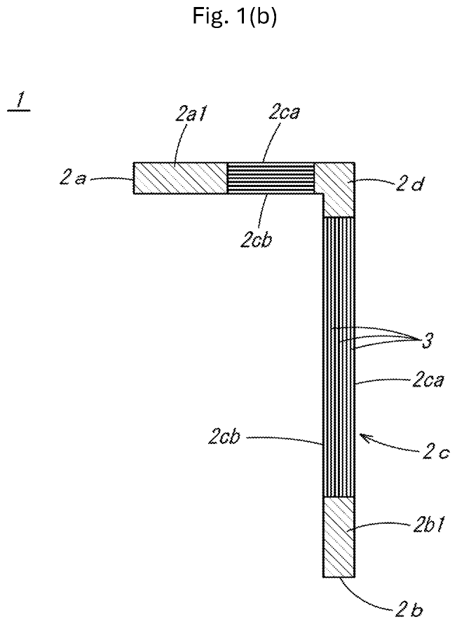

The flexible bus bar 1 according to the present embodiment can be subjected to a bending process that can not only prevent the occurrence of a phenomenon in which wrinkles are formed but also stabilize the quality of a product. More specifically, the flexible bus bar 1 shown in FIG. 1 includes a flexible bus bar main body 2.

As shown in FIG. 1(a), the flexible bus bar main body 2 is formed in a horizontally long rectangular shape in plan view, and as shown in FIG. 1(b), is formed by laminating conductive material foils 3 made of a thin plate-shaped, flexible metal such as copper. It is noted that the flexible bus bar main body 2 formed in this manner can carry a large current.

Thus, in the flexible bus bar main body 2 configured in this manner, as shown in FIG. 1(a), a left side surface 2a side is fixed by thermal bonding to form a left fixing portion 2a1, and a right side surface 2b side is fixed by thermal bonding to form a right fixing portion 2b1. As a result, as shown in FIG. 1(a), an unfixed portion 2c is formed between the left fixing portion 2a1 and the right fixing portion 2b1, and the unfixed portion 2c has flexibility.

Therefore, the flexible bus bar 1 is configured in this manner.

As shown in FIG. 1(a), in the unfixed portion 2c, a bending-specific fixing portion 2d fixed by thermal bonding is formed in a left portion on the center side in addition to the above-described left fixing portion 2a1 and the right fixing portion 2b1. As shown in FIG. 1(a), the bending-specific fixing portion 2d is arranged so as to include a bending line S1 for bending the flexible bus bar main body 2 by 90 degrees.

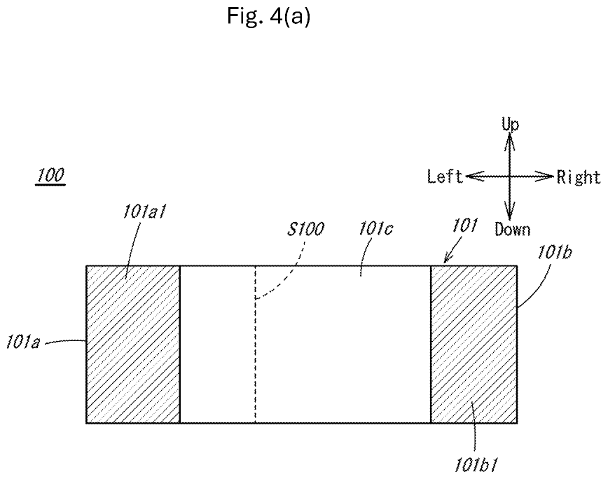

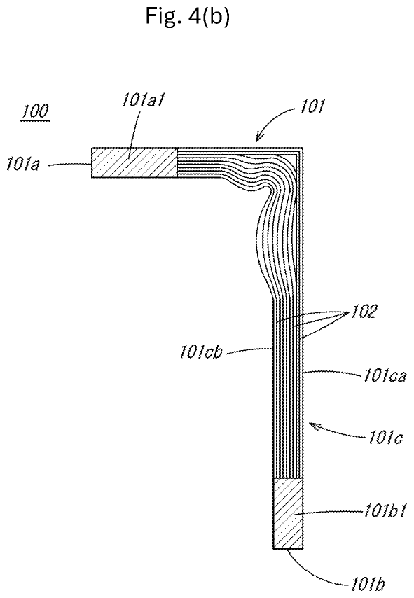

Thus, when such a bending-specific fixing portion 2d is formed and the flexible bus bar 1, that is, the flexible bus bar main body 2, is subjected to a bending process along the bending line S1 shown in FIG. 1(a), the state shown in FIG. 1(b) is obtained. That is, by this bending process, as shown in FIG. 1(b), no distance difference, that is, no inner-outer difference, occurs between the conductive material foil 3 located on the outermost peripheral surface 2ca side in the unfixed portion 2c and the conductive material foil 3 located on the innermost peripheral surface 2cb side. In other words, due to the bending-specific fixing portion 2d, as shown in FIG. 1(b), the portion of the unfixed portion 2c having flexibility is not involved in the bending process and therefore is not affected at all by the bending process. Accordingly, no distance difference, that is, no inner-outer difference, occurs. Accordingly, a phenomenon in which wrinkles are formed, as shown in FIG. 4(b), in the conductive material foil 3 located on the innermost peripheral surface 2cb side due to the occurrence of the distance difference, that is, the inner-outer difference, does not occur.

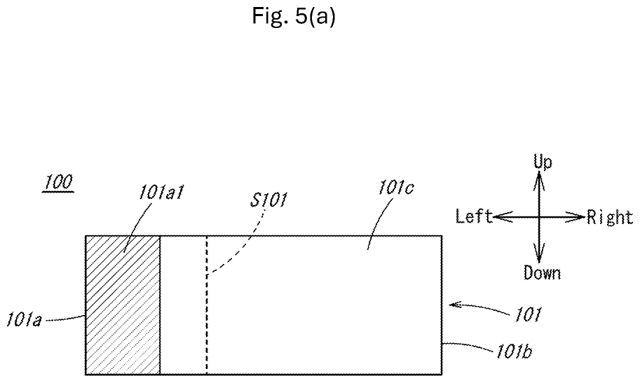

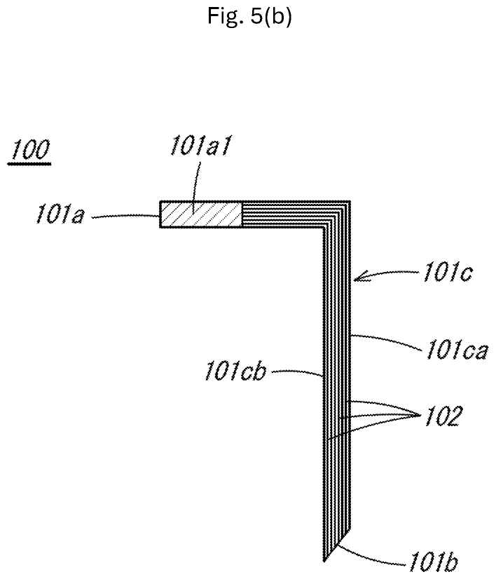

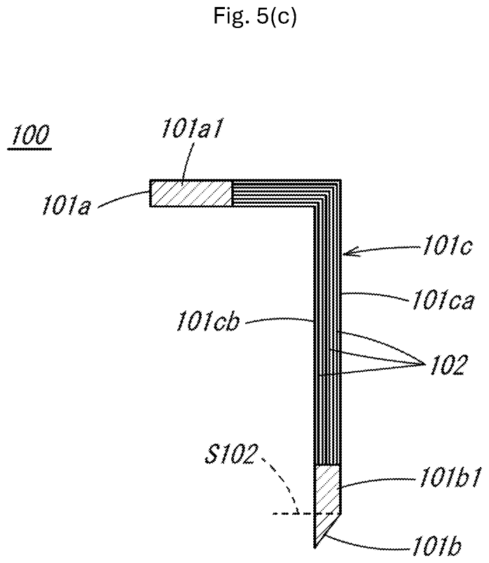

Furthermore, there is also no need to perform cutting processing, as shown in FIG. 5(c), for aligning the end surface of the right fixing portion 2b1 (the right side surface 2b of the flexible bus bar main body 2), which would otherwise be required due to the occurrence of the distance difference, that is, the inner-outer difference.

Therefore, according to the present embodiment described above, since no distance difference, that is, no inner-outer difference, occurs between the conductive material foil 3 located on the outermost peripheral surface 2ca side in the unfixed portion 2c and the conductive material foil 3 located on the innermost peripheral surface 2cb side, not only does the conventional phenomenon in which wrinkles are formed not occur, but also the problem does not occur that the number of cutting steps increases, product variation tends to occur, and product quality may become unstable.

Therefore, according to the present embodiment, not only can appearance be improved, but also the quality of a product can be stabilized.

Further, according to the present embodiment, since the bending-specific fixing portion 2d is formed only in the portion located at the bending line S1 shown in FIG. 1(a), the influence on the flexibility of the unfixed portion 2c can be minimized. Accordingly, the flexibility of the unfixed portion 2c can be exhibited to the maximum extent.

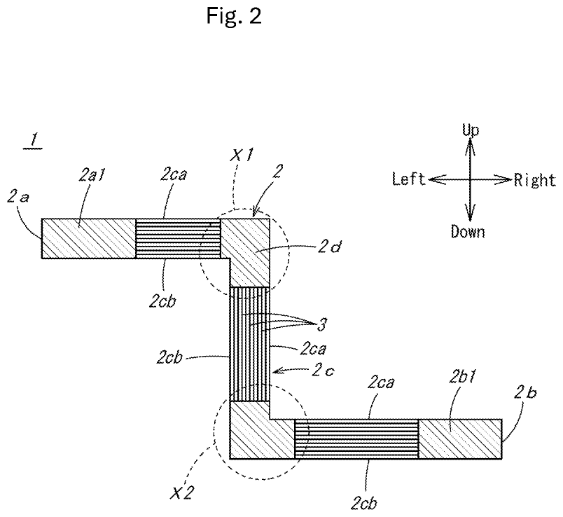

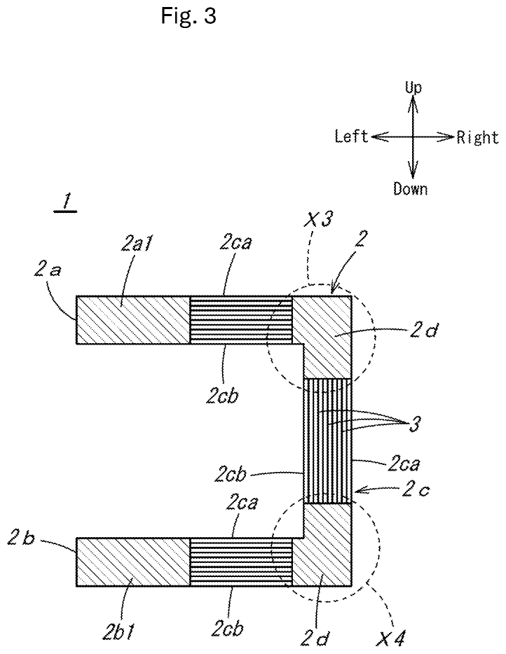

Furthermore, when the bending-specific fixing portion 2d as described above is formed, complicated bending processes as shown in FIGS. 2 and 3 also become possible. That is, as shown in FIG. 2, when the flexible bus bar 1, that is, the flexible bus bar main body 2, is subjected to a bending process and formed in a stair-step shape, the bending-specific fixing portion 2d may be formed in each of the portions to be subjected to a bending process (portions indicated by broken lines X1 and X2 in FIG. 2). Further, as shown in FIG. 3, when the flexible bus bar 1, that is, the flexible bus bar main body 2, is subjected to a bending process and formed in a U-shape, the bending-specific fixing portion 2d may be formed in each of the portions to be subjected to a bending process (portions indicated by broken lines X3 and X4 in FIG. 3). As a result, even when a complicated bending process is performed, no distance difference, that is, no inner-outer difference, occurs between the conductive material foil 3 located on the outermost peripheral surface 2ca side in the unfixed portion 2c and the conductive material foil 3 located on the innermost peripheral surface 2cb side, and therefore a phenomenon in which wrinkles are formed as in the conventional art does not occur. Furthermore, since there is also no need to perform cutting processing, as shown in FIG. 5(c), for aligning the end surface of the right fixing portion 2b1 (the right side surface 2b of the flexible bus bar main body 2), which would otherwise be required due to the occurrence of the distance difference, that is, the inner-outer difference, a problem in which the number of cutting steps increases, product variation tends to occur, and product quality may become unstable does not occur either.

Accordingly, when the bending-specific fixing portion 2d is formed in each of the portions to be subjected to a bending process (portions indicated by broken lines X1 and X2 in FIG. 2 and portions indicated by broken lines X3 and X4 in FIG. 3), appearance can not only be improved, but product quality can also be stabilized, and furthermore a complicated bending process becomes possible.

It is noted that shapes and the like shown in the present embodiment are merely examples, and various modifications and changes are possible within the scope of the gist of the present invention described in the claims.

For example, although the present embodiment has shown an example in which the left fixing portion 2a1, the right fixing portion 2b1, and the bending-specific fixing portion 2d are formed by thermal bonding, formation is not limited thereto, and formation may be performed using solder or the like. However, thermal bonding is preferable. The reason is that, when formation is performed using solder or the like, there is a possibility that a brazing material used in solder or the like will melt when heat is applied to the flexible bus bar 1, and furthermore there is a possibility that a required resistance value for the flexible bus bar 1 will not be obtained due to the influence of a member used in solder or the like. Accordingly, thermal bonding is preferable.

Further, in the present embodiment, 90 degrees has been described as an example of the bending process, but the bending process is of course not limited thereto and can be applied to various bending angles such as 80 degrees and 100 degrees.

What is claimed:

1. A flexible bus bar comprising:
a flexible bus bar main body having flexibility; and
first fixing portions that fix both side portions of the flexible bus bar main body,
wherein, upon bending of the flexible bus bar main body at a predetermined position, a second fixing portion that includes the predetermined position is formed on the flexible bus bar main body in addition to the first fixing portions.

2. The flexible bus bar according to claim 1, wherein, upon bending of the flexible bus bar main body at each of a plurality of predetermined positions, the second fixing portion is formed on the flexible bus bar main body at each of the plurality of predetermined positions so as to include a respective one of the plurality of predetermined positions, in addition to the first fixing portions.

3. The flexible bus bar according to claim 1, wherein the first fixing portions and the second fixing portion are formed by thermal bonding.

4. The flexible bus bar according to claim 2, wherein the first fixing portions and the second fixing portion are formed by thermal bonding.
